(19) United States
(12) Patent Application Publication
(10) Pub. No.: US 2014/0244259 A1
(43) Pub. Date: Aug. 28, 2014

(54) SPEECH RECOGNITION UTILIZING A DYNAMIC SET OF GRAMMAR ELEMENTS

(71) Applicants: Barbara Rosario, Berkeley, CA (US); Victor B. Lortz, Beaverton, OR (US); Anand P. Rangarajan, Beaverton, OR (US); Vijay Kesavan, Hillsboro, OR (US); David L. Graumann, Portland, OR (US)

(72) Inventors: Barbara Rosario, Berkeley, CA (US); Victor B. Lortz, Beaverton, OR (US); Anand P. Rangarajan, Beaverton, OR (US); Vijay Kesavan, Hillsboro, OR (US); David L. Graumann, Portland, OR (US)

(21) Appl. No.: 13/977,522

(22) PCT Filed: Dec. 29, 2011
(86) PCT No.: PCT/US2011/067825

§ 371 Date: May 2, 2014

(51) Int. Cl. G10L 15/08

(52) U.S. Cl. CPC G10L 15/08
USPC 704/254

(57) ABSTRACT

Speech recognition is performed utilizing a dynamically maintained set of grammar elements. A plurality of grammar elements may be identified, and the grammar elements may be ordered based at least in part upon contextual information. In other words, contextual information may be utilized to bias speech recognition. Once a speech input is received, the ordered plurality of grammar elements may be evaluated, and a correspondence between the received speech input and a grammar element included in the plurality of grammar elements may be determined.

### TECHNICAL FIELD

Aspects of the disclosure relate generally to speech recognition, and more particularly, to speech interfaces that dynamically manage grammar elements.

### BACKGROUND

Speech recognition technology has been increasingly deployed for a variety of purposes, including electronic dictation, voice command recognition, and telephone-based customer service engines. Speech recognition typically involves the processing of acoustic signals that are received via a microphone. In doing so, a speech recognition engine is typically utilized to interpret the acoustic signals into words or grammar elements. In certain environments, such as vehicular environments, the use of speech recognition technology enhances safety because drivers are able to provide instructions in a hands-free manner.

Additionally, in certain environments, such as vehicular environments, consumers may wish to execute multiple applications that incorporate speech recognition technology. However, there is a possibility that received speech commands and other inputs will be provided by a speech recognition engine to an incorrect application. Accordingly, there is an opportunity for improved systems and methods for dynamically managing grammar elements associated with speech recognition. Additionally, there is an opportunity for improved systems and methods for dispatching voice commands to appropriate applications.

### BRIEF DESCRIPTION OF THE FIGURES

Reference will now be made to the accompanying drawings, which are not necessarily drawn to scale, and wherein:

FIG. 1 is a block diagram of an example system or architecture that may be utilized to process speech inputs, according to an example embodiment of the disclosure.

FIG. 2 is a simplified schematic diagram of an example environment in which a speech recognition system may be implemented.

FIG. 3 is a flow diagram of an example method for providing speech input functionality.

FIG. 4 is a flow diagram of an example method for populating a dynamic set or list of grammar elements utilized for speech recognition.

FIG. 5 is a flow diagram of an example method for processing a received speech input.

### DETAILED DESCRIPTION

Embodiments of the disclosure may provide systems, methods, and apparatus for dynamically maintaining a set or plurality of grammar elements utilized in association with speech recognition. In this regard, as desired in various embodiments, a plurality of speech-enabled applications may be executed concurrently, and speech inputs or commands may be dispatched to the appropriate applications. For example, language models and/or grammar elements associated with each application may be identified, and the grammar elements may be organized based upon a wide variety of suitable contextual information associated with users and/or a speech recognition environment. During the processing of a received speech input, the organized grammar elements may be evaluated in order to identify the received speech input and dispatch a command to an appropriate application. Additionally, as desired in various embodiments, a set of grammar elements may be maintained and/or organized based upon the identification of one or more users and/or based upon a wide variety of contextual information associated with a speech recognition environment.

Various embodiments may be utilized in conjunction with a wide variety of different operating environments. For example, certain embodiments may be utilized in a vehicular environment. As desired, acoustic models within the vehicle may be optimized for use with specific hardware and various internal and/or external acoustics. Additionally, as desired, various language models and/or associated grammar elements may be developed and maintained for a wide variety of different users. In certain embodiments, language models relevant to the vehicle location and/or context may also be obtained from a wide variety of local and/or external sources.

In one example embodiment, a plurality of grammar elements associated with speech recognition may be identified by a suitable speech recognition system, which may include any number of suitable computing devices and/or associated software elements. The grammar elements may be associated with a wide variety of different language models identified by the speech recognition system, such as language models associated with one or more users, language models associated with any number of executing applications, and/or language models associated with a current location (e.g. a location of a vehicle, etc.). As desired, any number of suitable applications may be associated with the speech recognition system. For example, in a vehicular environment, vehicle-based applications (e.g., a stereo control application, a climate control application, a navigation application, etc.) and/or network-based or run time applications (e.g., a social networking application, an email application, etc.) may be associated with the speech recognition system.

Additionally, a wide variety of contextual information or environmental information may be determined or identified, such as identification information for one or more users, the identification information for one or more executing applications, actions taken by one or more executing applications, vehicle parameters (e.g., speed, current location, etc.), gestures made by a user, and/or a wide variety of user input (e.g., button presses, etc.). Based at least in part upon a portion of the contextual information, the plurality of grammar elements may be ordered or sorted. For example, a dynamic list of grammar elements may be sorted based upon the contextual information and, as desired, various weightings and/or priorities may be assigned to the various grammar elements.

Once a speech input is received for processing, the speech recognition system may evaluate the speech input and the ordered grammar elements in order to determine or identify a correspondence between the received speech input and a grammar element. For example, a list of ordered grammar elements may be traversed until the speech input is recognized. As another example, a probabilistic model may be utilized to identify a grammar element having a highest probability of matching the received speech input. Once a grammar element (or plurality of grammar elements) has been identified as matching the speech input, the speech recognition system may take a wide variety of suitable actions based upon the identified grammar elements. For example, an identified grammar element may be translated into an input that is provided to an executing application. In this regard, voice commands may be identified and dispatched to relevant applications.

Certain embodiments will now be described more fully hereinafter with reference to the accompanying drawings, in which various embodiments and/or aspects are shown. However, various aspects may be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

System Overview

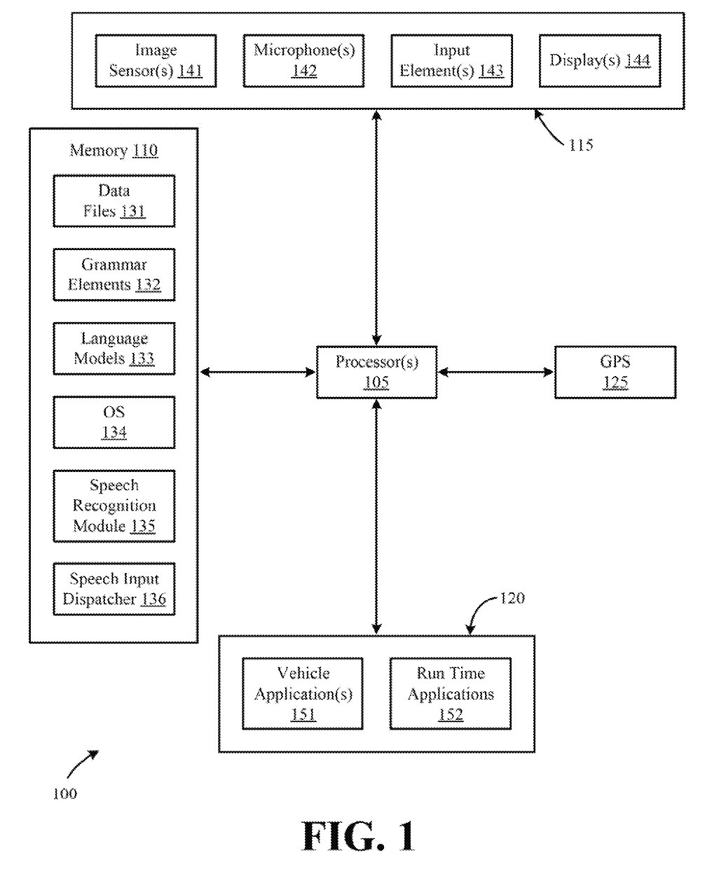

FIG. 1 illustrates a block diagram of an example system 100, architecture, or component that may be utilized to process speech inputs. In certain embodiments, the system 100 may be implemented or embodied as a speech recognition system. In other embodiments, the system 100 may be implemented or embodied as a component of another system or device, such as an in-vehicle infotainment (“IVI”) system associated with a vehicle. In yet other embodiments, one or more suitable computer-readable media may be provided for processing speech input. These computer-readable media may include computer-executable instructions that are executed by one or more processing devices in order to process speech input. As used herein, the term “computer-readable medium” describes any form of suitable memory or memory device for retaining information in any form, including various kinds of storage devices (e.g., magnetic, optical, static, etc.). Indeed, various embodiments of the disclosure may be implemented in a wide variety of suitable forms.

As desired, the system 100 may include any number of suitable computing devices associated with suitable hardware and/or software for processing speech input. These computing devices may also include any number of processors for processing data and executing computer-executable instructions, as well as other internal and peripheral components that are well-known in the art. Further, these computing devices may include or be in communication with any number of suitable memory devices operable to store data and/or computer-executable instructions. By executing computer-executable instructions, a special purpose computer or particular machine for processing speech input may be formed.

With reference to FIG. 1, the system may include one or more processors 105 and memory devices 110 (generally referred to as memory 110). Additionally, the system may include any number of other components in communication with the processors 105, such as any number of input/output (“I/O”) devices 115, any number of suitable applications 120, and/or a suitable global positioning system (“GPS”) or other location determination system. The processors 105 may include any number of suitable processing devices, such as a central processing unit (“CPU”), a digital signal processor (“DSP”), a reduced instruction set computer (“RISC”), a complex instruction set computer (“CISC”), a microprocessor, a microcontroller, a field programmable gate array (“FPGA”), or any combination thereof. As desired, a chipset (not shown) may be provided for controlling communications between the processors 105 and one or more of the other components of the system 100. In one embodiment, the system 100 may be based on an Intel® Architecture system, and the processor 105 and chipset may be from a family of Intel® processors and chipsets, such as the Intel® Atom® processor family. The processors 105 may also include one or more processors as part of one or more application-specific integrated circuits (“ASICs”) or application-specific standard products (“ASSPs”) for handling specific data processing functions or tasks. Additionally, any number of suitable 110 interfaces and/or communications interfaces (e.g., network interfaces, data bus interfaces, etc.) may facilitate communication between the processors 105 and/or other components of the system 100.

The memory 110 may include any number of suitable memory devices, such as caches, read-only memory devices, random access memory (“RAM”), dynamic RAM (“DRAM”), static RAM (“SRAM”), synchronous dynamic RAM (“SDRAM”), double data rate (“DDR”) SDRAM (“DDR-SDRAM”), RAM-BUS DRAM (“RDRAM”), flash memory devices, electrically erasable programmable read only memory (“EEPROM”), non-volatile RAM (“NVRAM”), universal serial bus (“USB”) removable memory, magnetic storage devices, removable storage devices (e.g., memory cards, etc.), and/or non-removable storage devices. As desired, the memory 110 may include internal memory devices and/or external memory devices in communication with the system 100. The memory 110 may store data, executable instructions, and/or various program modules utilized by the processors 105. Examples of data that may be stored by the memory 110 include data files 131, information associated with grammar elements 132, information associated with language models 133, and/or any number of suitable program modules and/or applications that may be executed by the processors 105, such as an operating system (“OS”) 134, a speech recognition module 135, and/or a speech input dispatcher 136.

The data files 131 may include any suitable data that facilitates the operation of the system 100, the identification of grammar elements 132 and/or language models 133, and/or the processing of speech input. For example, the stored data files 131 may include, but are not limited to, user profile information, information associated with the identification of users, information associated with the applications 120, and/or a wide variety of contextual information associated with a vehicle or other speech recognition environment, such as location information. The grammar element information 132 may include a wide variety of information associated with a plurality of different grammar elements (e.g., commands, speech inputs, etc.) that may be recognized by the speech recognition module 135. For example, the grammar element information 132 may include a dynamically generated and/or maintained list of grammar elements associated with any number of the applications 120, as well as weightings and/or priorities associated with the grammar elements. The language model information 133 may include a wide variety of information associated with any number of language models, such as statistical language models, utilized in association with speech recognition. In certain embodiments, these language models may include models associated with any number of users and/or applications. Additionally or alternatively, as desired in various embodiments, these language models may include models identified and/or obtained in conjunction with a wide variety of contextual information. For example, if a vehicle travels to a particular location (e.g. a particular city), one or more language models associated with the location may be identified and, as desired, obtained from any number of suitable data sources. In certain embodiments, the various grammar elements included in a list or set of grammar elements may be determined or derived from applicable language models. For example, declarations of grammar associated with certain commands and/or other speech input may be determined from a language model.

The OS 134 may be a suitable module or application that facilitates the general operation of a speech recognition and/or processing system, as well as the execution of other program modules, such as the speech recognition module 135 and/or the speech input dispatcher. The speech recognition module 135 may include any number of suitable software modules and/or applications that facilitate the maintenance of a plurality of grammar elements and/or the processing of received speech input. In operation, the speech recognition module 135 may identify applicable language models and/or associated grammar elements, such as language models and/or associated grammar elements associated with executing applications, identified users, and/or a current location of a vehicle. Additionally, the speech recognition module 135 may evaluate a wide variety of contextual information, such as user preferences, application identifications, application priorities, application outputs and/or actions, vehicle parameters (e.g., speed, current location, etc.), gestures made by a user, and/or a wide variety of user input (e.g., button presses, etc.), in order to order and/or sort the grammar elements. For example, a dynamic list of grammar elements may be sorted based upon the contextual information and, as desired, various weightings and/or priorities may be assigned to the various grammar elements.

Once a speech input is received for processing, the speech recognition module 135 may evaluate the speech input and the ordered grammar elements in order to determine or identify a correspondence between the received speech input and a grammar element. For example, a list of ordered and/or prioritized grammar elements may be traversed by the speech recognition module 135 until the speech input is recognized. As another example, a probabilistic model may be utilized to identify a grammar element having a highest probability of matching the received speech input. Additionally, as desired, a wide variety of contextual information may be taken into consideration during the identification of a grammar element.

Once a grammar element (or plurality of grammar elements) has been identified as matching the speech input, the speech recognition module 135 may provide information associated with the grammar elements to the speech input dispatcher 136. The speech input dispatcher 136 may include any number of suitable modules and/or applications configured to provide and/or dispatch information associated with recognized speech inputs (e.g., voice commands) to any number of suitable applications 120. For example, an identified grammar element may be translated into an input that is provided to an executing application. In this regard, voice commands may be identified and dispatched to relevant applications 120. Additionally, as desired, a wide variety of suitable vehicle information and/or vehicle parameters may be provided to the applications 120. In this regard, the applications may adjust their operation based upon the vehicle information. In certain embodiments, the speech input dispatcher 136 may additionally process a recognized speech input in order to generate output information (e.g., audio output information, display information, messages for communication, etc.) for presentation to a user. For example, an audio output associated with the recognition and/or processing of a voice command may be generated and output. As another example, a visual display may be updated by the speech input dispatcher 136 based upon the processing of a voice command.

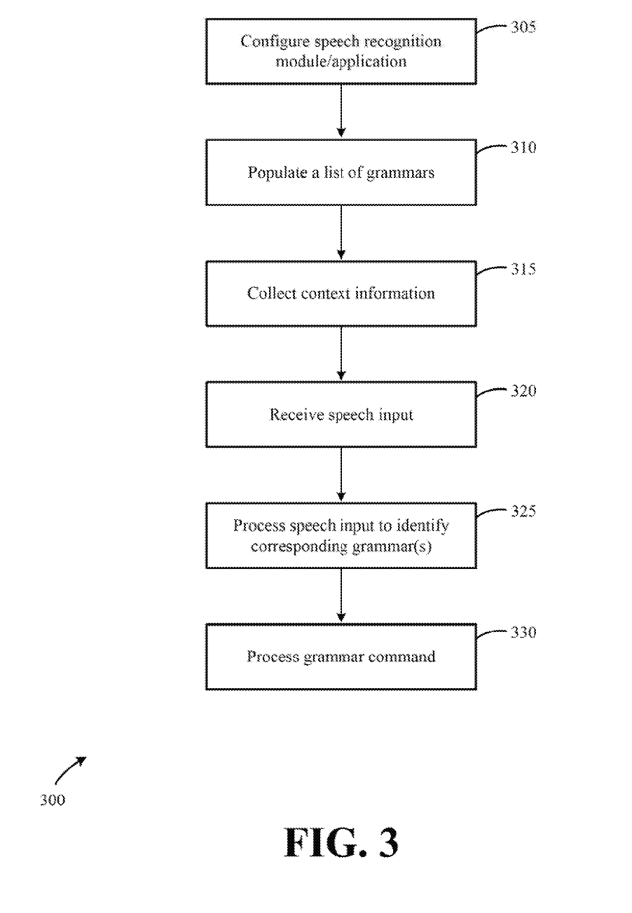

As desired, the speech recognition module 135 and/or the speech input dispatcher 136 may be implemented as any number of suitable modules. Alternatively, a single module may perform functions of both the speech recognition module 135 and the speech input dispatcher 136. A few examples of the operations of the speech recognition module 135 and/or the speech input dispatcher 136 are described in greater detail below with reference to FIGS. 3-5.

With continued reference to FIG. 1, the I/O devices 115 may include any number of suitable devices that facilitate the collection of information to be provided to the processors 105 and/or the output of information for presentation to a user. Examples of suitable input devices include, but are not limited to, one or more image sensors 141 (e.g., a camera, etc.), one or more microphones 142 or other suitable audio capture devices, any number of suitable input elements 143, and/or a wide variety of other suitable sensors (e.g., infrared sensors, range finders, etc.). Examples of suitable output devices include, but are not limited to, one or more speakers and/or one or more displays 144. Other suitable input and/or output devices may be utilized as desired.

The image sensors 141 may include any known devices that convert optical images to an electronic signal, such as cameras, charge coupled devices (“CCDs”), complementary metal oxide semiconductor (“CMOS”) sensors, or the like. In operation, data collected by the image sensors 141 may be processed in order to determine or identify a wide variety of suitable contextual information. For example, image data may be evaluated in order to identify users, detect user indications, and/or to detect user gestures. Similarly, the microphones 142 may include microphones of any known type including, but not limited to, condenser microphones, dynamic microphones, capacitance diaphragm microphones, piezoelectric microphones, optical pickup microphones, and/or various combinations thereof. In operation, a microphone 142 may collect sound waves and/or pressure waves, and provide collected audio data (e.g., voice data) to the processors 105 for evaluation. In this regard, various speech inputs may be recognized. Additionally, in certain embodiments, collected voice data may be compared to stored profile information in order to identify one or more users.

The input elements 143 may include any number of suitable components and/or devices configured to receive user input. Examples of suitable input elements include, but are not limited to, buttons, knobs, switches, touch screens, capacitive sensing elements, etc. The displays 144 may include any number of suitable display devices, such as a liquid crystal display (“LCD”), a light-emitting diode (“LED”) display, an organic light-emitting diode (“OLED”) display, and/or a touch screen display.

Additionally, in certain embodiments, communication may be established via any number of suitable networks (e.g., a Bluetooth-enabled network, a Wi-Fi network, a wired network, a wireless network, etc.) with any number of user devices, such as mobile devices and/or tablet computers. In this regard, input information may be received from the user devices and/or output information may be provided to the user devices. Additionally, communication may be established via any number of suitable networks (e.g., a cellular network, the Internet, etc.) with any number of suitable data sources and/or network servers. In this regard, language model information and/or other suitable information may be obtained. For example, based upon a location of a vehicle, one or more language models associated with the location may be obtained from one or more data sources. As desired, one or more communication interfaces may facilitate communication with the user devices and/or data sources.

With continued reference to FIG. 1, any number of applications 120 may be associated with the system 100. As desired, information associated with recognized speech inputs may be provided to the applications 120 by the speech input dispatcher 136. In certain embodiments, one or more of the applications 120 may be executed by the processors 105. As desired, one or more of the applications 120 may be executed by other processing devices in network communication with the processors 105. In an example vehicular embodiment, the applications 120 may include any number of vehicle applications 151 and/or any number of run time or network-based applications 152. The vehicle applications 151 may include any suitable applications associated with a vehicle, including but not limited to, a stereo control application, a climate control application, a navigation application, a maintenance application, an application that monitors various vehicle parameters (e.g., speed, etc.) and/or an application that manages communication with other vehicles. The run time applications 152 may include any number of network-based applications that may communicate with the processors 105 and/or speech input dispatcher 136, such as Web or network-hosted applications and/or applications executed by user devices. Examples of suitable run time applications 152 include, but are not limited to, social networking applications, email applications, travel applications, gaming applications, etc. As desired, information associated with a suitable voice interaction library and associated markup notation may be provided to Web and/or application developers to facilitate the programming and/or modification of run time applications 152 to add context-aware speech recognition functionality.

The GPS 125 may be any suitable device configured to determine location based upon interaction with a network of GPS satellites. The GPS 125 may provide location information (e.g., coordinates) and/or information associated with changes in location to the processors 105 and/or to a suitable navigation system. In certain embodiments, the location information may be contextual information evaluated during the maintenance of grammar elements and/or the processing of speech inputs.

The system 100 or architecture described above with reference to FIG. 1 is provided by way of example only. As desired, a wide variety of other systems and/or architectures may be utilized to process speech inputs utilizing a dynamically maintained set or list of grammar elements. These systems and/or architectures may include different components and/or arrangements of components than that illustrated in FIG. 1.

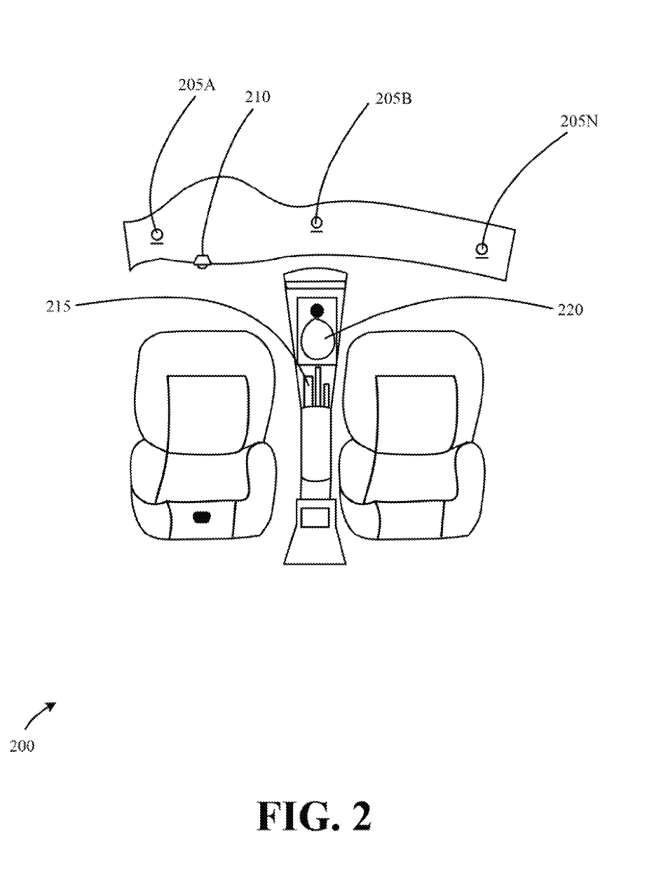

FIG. 2 is a simplified schematic diagram of an example environment 200 in which a speech recognition system may be implemented. The environment 200 of FIG. 2 is a vehicular environment, such as an environment associated with an automobile or other vehicle. With reference to FIG. 2, the cockpit area of a vehicle is illustrated. The environment 200 may include one or more seats, a dashboard, and a console. Additionally, a wide variety of suitable sensors, input elements, and/or output devices may be associated with the environment 200. These various components and/or devices may facilitate the collection of speech input and contextual information, as well as the output of information to one or more users (e.g., a driver, etc.)

With reference to FIG. 2, any number of microphones 205A-N, image sensors 210, input elements 215, and/or displays 220 may be provided. The microphones 205A-N may facilitate the collection of speech input and/or other audio input to be evaluated or processed. In certain embodiments, collected speech input may be evaluated in order to identify one or more users within the environment. Additionally, collected speech input may be provided to a suitable speech recognition module or system to facilitate the identification of spoken commands. The image sensors 210 may facilitate the collection of image data that may be evaluated for a wide variety of suitable purposes, such as user identification and/or the identification of user gestures. In certain embodiments, a user gesture may indicate when speech input recognition should begin and/or terminate. In other embodiments, a user gesture may provide contextual information associated with the processing of speech inputs. For example, a user may gesture towards a sound system (or a designated area associated with the sound system) to indicate that a speech input is associated with the sound system.

The input elements 215 may include any number of suitable components and/or devices that facilitate the collection of physical user inputs. For example, the input elements 215 may include buttons, switches, knobs, capacitive sensing elements, touch screen display inputs, and/or other suitable input elements. Selection of one or more input elements 215 may initiate and/or terminate speech recognition, as well as provide contextual information associated with speech recognition. For example, a last selected input element or an input element selected during the receipt of a speech input (or relatively close in time following the receipt of a speech input) may be evaluated in order to identify a grammar element or command associated with the speech input. In certain embodiments, a gesture towards an input element may also be identified by the image sensors 210. Although the input elements 215 are illustrated as being components of the console, input elements 215 may be situated at any suitable points within the environment 200, such as on a door, on the dashboard, on the steering wheel, and/or on the ceiling. The displays 220 may include any number of suitable display devices, such as a liquid crystal display (“LCD”), a light-emitting diode (“LED”) display, an organic light-emitting diode (“OLED”) display, and/or a touch screen display. As desired, the displays 220 may facilitate the output of a wide variety of visual information to one or more users. In certain embodiments, a gesture towards a display (e.g., pointing at a display, gazing towards the display, etc.) may be identified and evaluated as suitable contextual information.

The environment 200 illustrated in FIG. 2 is provided by way of example only. As desired, various embodiments may be utilized in a wide variety of other environments. Indeed, embodiments may be utilized in any suitable environment in which speech recognition is implemented.

Operational Overview

FIG. 3 is a flow diagram of an example method 300 for providing speech input functionality. In certain embodiments, the operations of the method 300 may be performed by a suitable speech input system and/or one or more associated modules and/or applications, such as the speech input system 100 and/or the associated speech recognition module 135 illustrated in FIG. 1. The method 300 may begin at block 305.

At block 305, a speech recognition module or application 135 may be configured and/or implemented. As desired, a wide variety of different types of configuration information may be taken into account during the configuration of the speech recognition module 135. Examples of configuration information include, but are not limited to, an identification of one or more users (e.g., a driver, a passenger, etc.), user profile information, user preferences and/or parameters associated with identifying speech input and/or obtaining language models, identifications of one or more executing applications (e.g., vehicle applications, run time applications), priorities associated with the applications, information associated with actions taken by the applications, one or more vehicle parameters (e.g., location, speed, etc.), and/or information associated with received user inputs (e.g., input element selections, gestures, etc.).

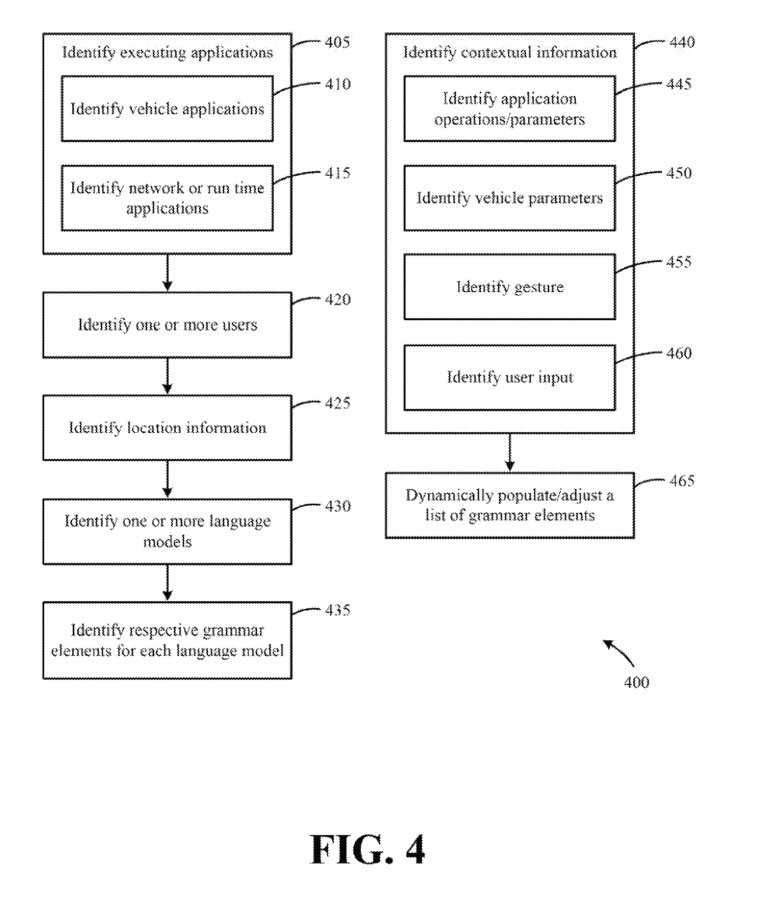

As explained in greater detail below with reference to FIG. 4, at least a portion of the configuration information may be utilized to identify a wide variety of different language models associated with speech recognition. Each of the language models may be associated with any number of respective grammar elements. At block 310, a set of grammar elements, such as a list of grammar elements, may be populated by the speech recognition module 135. The grammar elements may be utilized to identify commands and/or other speech inputs subsequently received by the speech recognition module 135. In certain embodiments, the set of grammar elements may be dynamically populated based at least in part upon a portion of the configuration information. The dynamically populated grammar elements may be ordered or otherwise organized (e.g., assigned priorities, assigned weightings, etc.) such that priority is granted to certain grammar elements. In other words, a voice interaction library may pre-process grammar elements and/or grammar declarations in order to influence subsequent speech recognition processing. In this regard, during the processing of speech inputs, priority, but not exclusive consideration, may be given to certain grammar elements.

As one example of dynamically populating and/or ordering a set of grammar elements, grammar elements associated with certain users (e.g., an identified driver, etc.) may be given a relatively higher priority (e.g., ordered earlier in a list, assigned a relatively higher priority or weight, etc.) than grammar elements associated with other users. As another example, user preferences and application priorities may be taken into consideration during the population of a grammar element list or during the assigning of respective priorities to grammar elements. As other examples, application actions (e.g., the receipt of an email or text message by an application, the generation of an alert, the receipt of an incoming telephone call, the receipt of a meeting request, etc.), received user inputs, identified gestures, and/or other configuration and/or contextual information may be taken into consideration during the dynamic population of a set of grammar elements.

At block 315, at least one item of contextual or context information may be collected and/or received. A wide variety of contextual information may be collected as desired in various embodiments of the invention, such as an identification of one or more users (e.g., an identification of a speaker), information associated with status changes of applications (e.g. newly executed applications, terminated applications, etc.), information associated with actions taken by the applications, one or more vehicle parameters, (e.g., location, speed, etc.), and/or information associated with received user inputs (e.g., input element selections, gestures, etc.). In certain embodiments, the contextual information may be utilized to adjust and/or modify the list or set of grammar elements. For example, contextual information may be continuously received, periodically received, and/or received based upon one or more identified or detected events (e.g., application outputs, gestures, received inputs, etc.). The received contextual information may then be utilized to adjust the orderings and/or priorities of the grammar elements. In other embodiments, contextual information may be received or identified in association with the receipt of a speech input, and the contextual information may be evaluated in order to select a grammar element from the set of grammar elements. As another example, if an application is closed or terminated, grammar elements associated with the application may be removed from the set of grammar elements.

At block 320, a speech input or audio input may be received. For example, speech input collected by one or more microphones or other audio capture devices may be received. In certain embodiments, the speech input may be received based upon the identification of a speech recognition command. For example, a user selection of an input element or the identification of a user gesture associated with the initiation of speech recognition may be identified, and speech input may then be received following the selection or identification.

Once the speech input is received, at block 325, the speech input may be processed in order to identify one or more corresponding grammar elements. For example, in certain embodiments, a list of ordered and/or prioritized grammar elements may be traversed until one or more corresponding grammar elements are identified. In other embodiments, a probabilistic model may determine or compute the probabilities of various grammar elements corresponding to the speech input. As desired, the identification of a correspondence may also take a wide variety of contextual information into consideration. For example, input element selections, actions taken by one or more applications, user gestures, and/or any number of vehicle parameters may be taken into consideration in order to identify grammar elements corresponding to a speech input. In this regard, a suitable voice command or other speech input may be identified with relatively high accuracy.

Certain embodiments may simplify the determination of grammar elements to identify and/or utilize in association with speech recognition. For example, by ordering grammar elements associated with the most recently activated applications and/or components higher in a list of grammar elements, the speech recognition module may be biased towards those grammar elements. Such an approach may apply the heuristic that speech input is most likely to be directed towards components and/or applications that have most recently come to a user's attention. For example, if a message has recently been output by an application or component, speech recognition may be biased towards commands associated with the application or component. As another example, if a user indication associated with a particular component or application has recently been identified, then speech recognition may be biased towards commands associated with the application or component.

At block 330, once a grammar element (or plurality of grammar elements) has been identified as matching the speech input, a command or other suitable input may be determined. Information associated with the command may then be provided, for example, by a speech input dispatcher, to any number of suitable applications. For example, an identified grammar element or command may be translated into an input that is provided to an executing application. In this regard, voice commands may be identified and dispatched to relevant applications. Additionally, in certain embodiments, a recognized speech input may be processed in order to generate output information (e.g., audio output information, display information, messages for communication, etc.) for presentation to a user. For example, an audio output associated with the recognition and/or processing of a voice command may be generated and output. As another example, a visual display may be updated based upon the processing of a voice command. The method 300 may end following block 330.

FIG. 4 is a flow diagram of an example method 400 for populating a dynamic set or list of grammar elements utilized for speech recognition. The operations of the method 400 may be one example of the operations performed at blocks 305 and 310 of the method 300 illustrated in FIG. 3. As such, the operations of the method 400 may be performed by a suitable speech input system and/or one or more associated modules and/or applications, such as the speech input system 100 and/or the associated speech recognition module 135 illustrated in FIG. 1. The method 400 may begin at block 405.

At block 405, one or more executing applications may be identified. A wide variety of applications may be identified as desired in various embodiments. For example, at block 410, one or more vehicle applications, such as a navigation application, a stereo control application, a climate control application, and/or a mobile device communications application, may be identified. As another example, at block 415, one or more run time or network applications may be identified. The run time applications may include applications executed by one or more processors and/or computing devices associated with a vehicle and/or applications executed by devices in communication with the vehicle (e.g., mobile devices, tablet computers, nearby vehicles, cloud servers, etc.). In certain embodiments, the run time applications may include any number of suitable browser-based and/or hypertext markup language (“HTML”) applications, such as Internet and/or cloud-based applications. During the identification of language models, as described in greater detail below with reference to block 430, one or more speech recognition language models associated with each of the applications may be identified or determined. In this regard, application-specific grammar elements may be identified for speech recognition purposes. As desired, various priorities and/or weightings may be determined for the various applications, for example, based upon user profile information and/or default profile information. In this regard, different priorities may be applied to the application language models and/or their associated grammar elements.

At block 420, one or more users associated with the vehicle (or another speech recognition environment) may be identified. A wide variety of suitable methods and/or techniques may be utilized to identify a user. For example, a voice sample of a user may be collected and compared to a stored voice sample. As another example, image data for the user may be collected and evaluated utilizing suitable facial recognition techniques. As another example, other biometric inputs (e.g., fingerprints, etc.) may be evaluated to identify a user. As yet another example, a user may be identified based upon determining a pairing between the vehicle and a user device (e.g., a mobile device, etc.) and/or based upon the receipt and evaluation of user identification information (e.g., a personal identification number, etc.) entered by the user. Once the one or more users have been identified, respective language models associated with each of the users may be identified and/or obtained (e.g., accessed from memory, obtained from a data source or user device, etc.). In this regard, user-specific grammar elements (e.g., user-defined commands, etc.) may be identified. In certain embodiments, priorities associated with the users may be determined and utilized to provide priorities and/or weighting to the language models and/or grammar elements. For example, higher priority may be provided to grammar elements associated with an identified driver of a vehicle.

Additionally, in certain embodiments, a wide variety of user parameters and/or preferences may be identified, for example, by accessing user profiles associated with identified users. The parameters and/or preferences may be evaluated and/or utilized for a wide variety of different purposes, for example, prioritizing executing applications, identifying and/or obtaining language models based upon vehicle parameters, and/or recognizing and/or identifying user-specific gestures.

At block 425, location information associated with the vehicle may be identified. For example, coordinates may be received from a suitable GPS component and evaluated to determine a location of the vehicle. As desired in various embodiments, a wide variety of other vehicle information may be identified, such as a speed, an amount of remaining fuel, or other suitable parameters. As described in greater detail below with reference to block 430, one or more speech recognition language models associated with the location information (and/or other vehicle parameters) may be identified or determined. For example, if the location information indicates that the vehicle is situated at or near San Francisco, one or more language models relevant to traveling in San Francisco may be identified, such as language models that include grammar elements associated with landmarks, points of interest, and/or features of interest in San Francisco. Example grammar elements for San Francisco may include, but are not limited to, “golden gate park,” “north beach,” “pacific height,” and/or any other suitable grammar elements associated with various points of interest. In certain embodiments, one or more user preferences may be taken into consideration during the identification of language models. For example, a user may specify that language models associated with tourist attractions should be obtained in the event that the vehicle travels outside of a designated home area. Additionally, once language models associated with a particular location are no longer relevant (i.e., the vehicle location has changed, etc.), the language models may be discarded.

As another example of obtaining or identifying language models associated with vehicle parameters, if it is determined from an evaluation of vehicle parameters that a vehicle speed is relatively constant, then a language model associated with a cruise control application and/or cruise control inputs may be accessed. As another example, if it is determined that a vehicle is relatively low on fuel, then a language model associated with the identification of a nearby gas station may be identified. Indeed, a wide variety of suitable language models may be identified based upon a vehicle location and/or other vehicle parameters.

At block 430, one or more language models may be identified based at least in part upon a wide variety of identified parameters and/or configuration information, such as application information, user information, location information, and/or other vehicle parameter information. Additionally, at block 435, respective grammar elements associated with each of the identified one or more language models may be identified or determined. In certain embodiments, a library, list, or other group of grammar elements or grammar declarations may be identified or built during the configuration and/or implementation of a speech recognition system or module. Additionally, the grammar elements may be organized or prioritized based upon a wide variety of user preferences and/or contextual information.

At block 440, at least one item of contextual information may be identified or determined. The contextual information may be utilized to organize the grammar elements and/or to apply priorities or weightings to the various grammar elements. In this regard, the grammar elements may be pre-processed prior to the receipt and processing of speech inputs. A wide variety of suitable contextual information may be identified as desired in various embodiments. For example, at block 445, parameters, operations, and/or outputs of one or more applications may be identified. As another example, at block 450, a wide variety of suitable vehicle parameters may be identified, such as updates in vehicle location, a vehicle speed, an amount of fuel, etc. As another example, at block 455, a user gesture may be identified. For example, collected image data may be evaluated in order to identify a user gesture. As yet another example, at block 460, any number of user inputs, such as one or more recently selected buttons or other input elements, may be identified.

At block 465, a set of grammar elements, such as a list of grammar elements, may be populated and/or ordered. As desired, various priorities and/or weightings may be applied to the grammar elements based at least in part upon the contextual information and/or any number of user preferences. In other words, pre-processing may be performed on the grammar elements in order to influence or bias subsequent speech recognition processing. In this regard, in certain embodiments, the grammar elements associated with different applications and/or users may be ordered. In the event that two applications or two users have identical or similar grammar elements, contextual information may be evaluated in order to provide higher priority to certain grammar elements over other grammar elements. Additionally, as desired, the set of grammar elements may be dynamically adjusted based upon the identification of a wide variety of additional information, such as additional contextual information and/or changes in the executing applications.

As one example of populating a list of grammar elements, application priorities may be evaluated in order to provide priority to grammar elements associated with higher priority applications. As another example, grammar elements associated with a recent output or operation of an application (e.g., a received message, a generated warning, etc.) may be provided with a higher priority than other grammar elements. For example, if a text message has recently been received by a messaging application, then grammar elements associated with outputting and/or responding to the text message may be provided with a higher priority. As another example, as a vehicle location changes, grammar elements associated with nearby points of interest may be provided with a higher priority. As another example, a most recently identified user gesture or user input may be evaluated in order to provide grammar elements associated with the gesture or input with a higher priority. For example, if a user gestures (e.g., gazes, points at, etc.) towards a stereo system, grammar elements associated with a stereo application may be provided with higher priorities.

The method 400 may end following block 465.

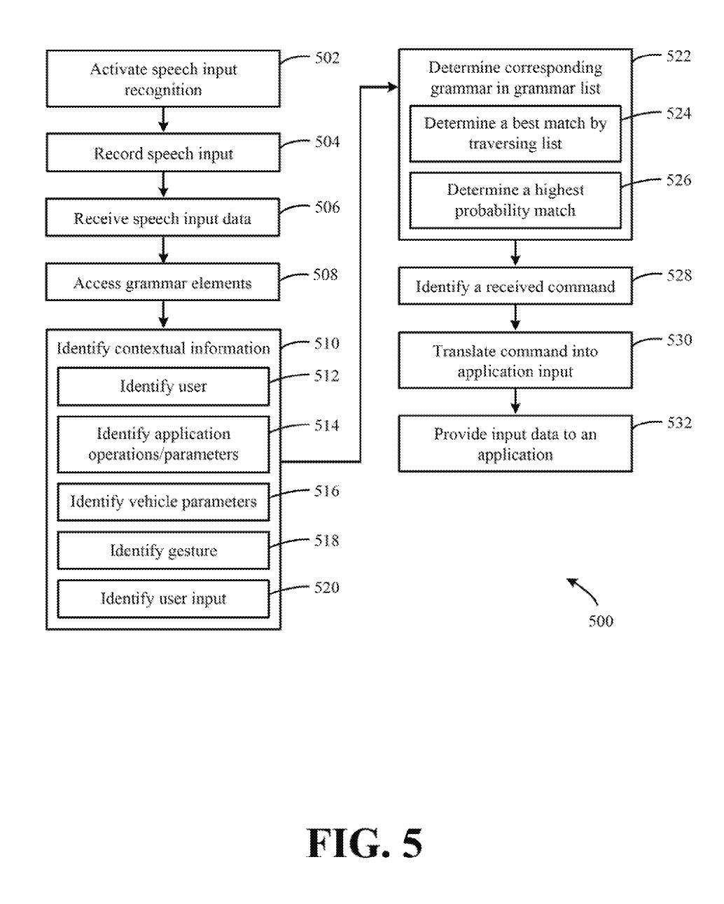

FIG. 5 is a flow diagram of an example method 500 for processing a received speech input. The operations of the method 500 may be one example of the operations performed at blocks 320-330 of the method 300 illustrated in FIG. 3. As such, the operations of the method 500 may be performed by a suitable speech input system and/or one or more associated modules and/or applications, such as the speech input system 100 and/or the associated speech recognition module 135 and/or speech input dispatcher 136 illustrated in FIG. 1. The method 500 may begin at block 502.

At block 502, speech input recognition may be activated. For example, a user gesture or input (e.g., a button press, etc.) associated with the initiation of speech recognition may be identified or detected. Once speech input recognition has been activated, speech input may be recorded by one or more audio capture devices (e.g., microphones, etc.) at block 504. Speech input data collected by the audio capture devices may then be received by a suitable speech recognition module 135 or speech recognition engine for processing at block 506.

At block 508, a set of grammar elements, such as a dynamically maintained list of grammar elements, may be accessed. At block 510, a wide variety of suitable contextual information associated with the received speech input may be identified. For example, at block 512, at least one user, such as a speaker of the speech input, may be identified based upon one or more suitable identification techniques (e.g. an evaluation of image data, processing of speech data, etc.). As another example, at block 514, any number of application operations and/or parameters may be identified, such as a message or warning generated by an application or a request for input generated by an application. As another example, at block 516, a wide variety of vehicle parameters (e.g., a location, a speed, an amount of remaining fuel, etc.) may be identified. As another example, at block 518, a gesture made by a user may be identified. As yet another example, a user selection of one or more input elements (e.g., buttons, knobs, etc.) may be identified at block 520. In certain embodiments, a plurality of items of contextual information may be identified. Additionally, as desired in certain embodiments, the grammar elements may be selectively accessed and/or sorted based at least in part upon the contextual information. For example, a speaker of the speech input may be identified, and grammar elements may be accessed, sorted, and/or prioritized based upon the identity of the speaker.

At block 522, a grammar element (or plurality of grammar elements) included in the set of grammar elements that corresponds to the received speech input may be determined. A wide variety of suitable methods or techniques may be utilized to determine a grammar element. For example, at block 524, an accessed list of grammar elements may be traversed (e.g., sequentially evaluated starting from the beginning or top, etc.) until a best match or correspondence between a grammar element and the speech input is identified. As another example, at block 526, a probabilistic model may be utilized to compute respective probabilities that various grammar elements included in the set of grammar elements correspond to the speech input. In this regard, a ranked list of grammar elements may be generated, and a higher probability match may be determined. Regardless of the determination method, in certain embodiments, the grammar element may be determined based at least in part upon the contextual information. In this regard, the speech recognition may be biased to give priority, but not exclusive consideration, to grammar elements corresponding to items of contextual information.

In certain embodiments, a plurality of applications may be associated with similar grammar elements. During the maintenance of a set of grammar elements and/or during speech recognition, contextual information may facilitate the identification of an appropriate grammar element associated with one of the plurality of applications. For example, the command “up” may be associated with a plurality of different applications, such as a stereo system application and/or an application that controls window functions. In the event that the last input element selected by a user is associated with a stereo system, a received command of “up” may be identified as a stereo system command, and the volume of the stereo may be increased. As another example, a warning message may be generated and output to the user indicating that maintenance should be performed for the vehicle. Accordingly, when a command of “tune up” is received, it may be determined that the command is associated with an application that schedules maintenance at a dealership and/or that maps a route to a service provider as opposed to a command that alters the tuning of a stereo system.

Once a grammar element (or plurality of grammar elements) corresponding to the speech input has been determined, a received command associated with the grammar element may be identified at block 528. In certain embodiments, a user may be prompted to confirm the command (or select an appropriate command from a plurality of potential commands or provide additional information that may be utilized to select the command). As desired, once the command has been identified, a wide variety of suitable actions may be taken based upon the identified command and/or parameters of one or more applications associated with the identified command. For example, at block 530, the identified command may translated into an input signal or input data to be provided to an application associated with the identified command. The input data may then be provided to or dispatched to the appropriate application at block 532. Additionally, as desired, a wide variety of suitable vehicle information and/or vehicle parameters may be provided to the applications. In this regard, the applications may adjust their operation based upon the vehicle information.

The method 500 may end following block 532.

The operations described and shown in the methods 300, 400, 500 of FIGS. 3-5 may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 3-5 may be performed.

Certain embodiments of the disclosure described herein may have the technical effect of biasing speech recognition based at least in part upon contextual information associated with a speech recognition environment. For example, in a vehicular environment, a gesture and/or selection of input elements by a user may be utilized to provide higher priority to grammar elements associated with the gesture or input elements. As a result, relatively accurate speech recognition may be performed. Additionally, speech recognition may be performed on behalf of a plurality of different applications, and voice commands may be dispatched and/or distributed to the various applications.

Certain aspects of the disclosure are described above with reference to block and flow diagrams of systems, methods, apparatus, and/or computer program products according to example embodiments. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, certain embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A speech recognition system comprising:
at least one memory configured to store a plurality of grammar elements;
at least one input device configured to receive a speech input; and
at least one processor configured to (i) identify at least one item of contextual information and (ii) determine, based at least in part upon the contextual information, a correspondence between the received speech input and a grammar element included in the plurality of grammar elements.

2. The speech recognition system of claim 1, wherein the at least one processor is further configured to identify a plurality of language models and direct, based at least in part upon the plurality of language models, storage of the plurality of grammar elements.

3. The speech recognition system of claim 1, wherein the contextual information comprises at least one of (i) an identification of a user, (ii) an identification of an action taken by an executing application, (iii) a parameter associated with a vehicle, (iv) a user gesture, or (v) a user input.

4. The speech recognition system of claim 1, wherein the at least one processor is further configured to order, based at least in part on the contextual information, the stored plurality of grammar elements and evaluate the ordered plurality of grammar elements to determine the correspondence between the received speech input and the grammar element.

5. A computer-implemented method comprising:
identifying, by a computing system comprising one or more computer processors, a plurality of grammar elements associated with speech recognition;
identifying, by the computing system, at least one item of contextual information;
ordering, by the computing system based at least in part on the contextual information, the plurality of grammar elements;
receiving, by the computing system, a speech input; and
determining, by the computing system based at least in part upon an evaluation of the ordered plurality of grammar elements, a correspondence between the received speech input and a grammar element included in the plurality of grammar elements.

6. The method of claim 5, wherein identifying a plurality of grammar elements comprises:
identifying a plurality of language models; and
determining, for each of the plurality of language models, a respective set of one or more grammar elements to be included in the plurality of grammar elements.

7. The method of claim 6, wherein identifying a plurality of language models comprises identifying at least one of (i) a language model associated with a user, (ii) a language model associated with an executing application, or (iii) a language model associated with a current location.

8. The method of claim 5, wherein identifying at least one item of contextual information comprises at least one of (i) identifying a user, (ii) identifying an action taken by an executing application, (iii) identifying a parameter associated with a vehicle, (iv) identifying a user gesture, or (v) identifying a user input.

9. The method of claim 5, wherein identifying a plurality of grammar elements comprises identifying a plurality of grammar elements associated with a plurality of executing applications.

10. The method of claim 9, wherein the plurality of applications comprise at least one of (i) a vehicle-based application or (ii) a network-based application.

11. The method of claim 5, wherein ordering the plurality of grammar elements comprises weighting the plurality of grammar elements based at least in part upon the contextual information.

12. The method of claim 5, further comprising:
translating, by the computing system, a recognized grammar element into an input; and
providing, by the computing system, the input to an application.

13. A system comprising:
at least one memory configured to store computer-executable instructions; and
at least one processor configured to access the at least one memory and execute the computer-executable instructions to:
identify a plurality of grammar elements associated with speech recognition;
receive a speech input;
identify at least one item of contextual information; and
determine, based at least in part upon the contextual information, a correspondence between the received speech input and a grammar element included in the plurality of grammar elements.

14. The system of claim 13, wherein the at least one processor is configured to identify the plurality of grammar elements by executing the computer-executable instructions to:
identify a plurality of language models; and
determine, for each of the plurality of language models, a respective set of one or more grammar elements to be included in the plurality of grammar elements.

15. The system of claim 14, wherein the plurality of language models comprise at least one of (i) a language model associated with a user, (ii) a language model associated with an executing application, or (iii) a language model associated with a current location.

16. The system of claim 13, wherein the contextual information comprises at least one of (i) an identification of a user, (ii) an identification of an action taken by an executing application, (iii) a parameter associated with a vehicle, (iv) a user gesture, or (v) a user input.

17. The system of claim 13, wherein the plurality of grammar elements comprise a plurality of grammar elements associated with a plurality of executing applications.

18. The system of claim 17, wherein the plurality of applications comprise at least one of (i) a vehicle-based application or (ii) a network-based application.

19. The system of claim 13, wherein the at least one processor is further configured to execute the computer-executable instructions to:
order, based at least in part on the contextual information, the plurality of grammar elements; and
evaluate the ordered plurality of grammar elements to determine the correspondence between the received speech input and the grammar element.

20. The system of claim 13, wherein the at least one processor is further configured to execute the computer-executable instructions to:
determine a probability between the received speech input and at least one grammar element included in the plurality of grammar elements; and
determine the correspondence based at least in part upon the determined probability.

21. The system of claim 13, wherein the at least one processor is further configured to execute the computer-executable instructions to:
translate a recognized grammar element into an input; and
direct provision of the input to an application.

22. At least one computer-readable medium comprising computer-executable instructions that, when executed by at least one processor, configure the at least one processor to:
identify a plurality of grammar elements associated with speech recognition;
receive a speech input;
identify at least one item of contextual information; and
determine, based at least in part upon the contextual information, a correspondence between the received speech input and a grammar element included in the plurality of grammar elements.

23. The computer-readable medium of claim 22, wherein the computer-executable instructions further configure the at least one processor to:
identify a plurality of language models; and
determine, for each of the plurality of language models, a respective set of one or more grammar elements to be included in the plurality of grammar elements.

24. The computer-readable medium of claim 23, wherein the plurality of language models comprise at least one of (i) a language model associated with a user, (ii) a language model associated with an executing application, or (iii) a language model associated with a current location.

25. The computer-readable medium of claim 22, wherein the contextual information comprises at least one of (i) an identification of a user, (ii) an identification of an action taken by an executing application, (iii) a parameter associated with a vehicle, (iv) a user gesture, or (v) a user input.

26. The computer-readable medium of claim 22, wherein the plurality of grammar elements comprise a plurality of grammar elements associated with a plurality of executing applications.

27. The computer-readable medium of claim 26, wherein the plurality of applications comprise at least one of (i) a vehicle-based application or (ii) a network-based application.

28. The computer-readable medium of claim 22, wherein the computer-executable instructions further configure the at least one processor to:
order, based at least in part on the contextual information, the plurality of grammar elements; and
evaluate the ordered plurality of grammar elements to determine the correspondence between the received speech input and the grammar element.

29. The computer-readable medium of claim 22, wherein the computer-executable instructions further configure the at least one processor to:
determine a probability between the received speech input and at least one grammar element included in the plurality of grammar elements; and
determine the correspondence based at least in part upon the determined probability.

30. The computer-readable medium of claim 22, wherein the computer-executable instructions further configure the at least one processor to:
translate a recognized grammar element into an input; and
direct provision of the input to an application.
